(19) United States
(12) Patent Application Publication
(10) Pub. No.: US 2008/0149114 A1
(43) Pub. Date: Jun. 26, 2008

(54) Awake airway: a glossal variant

(76) Inventor: Charles Craig Baldwin, Columbia, MD (US)

Correspondence Address: CHARLES C. BALDWIN, 5000 DUSTIN COURT, COLUMBIA, MD, 65203, US

(21) Appl. No.: 11/602,921

(22) Filed: Dec. 22, 2006

(51) Int. Cl. A61C 5/14

(52) U.S. Cl. 128/859

(57) ABSTRACT

The Awake Airway is an oral device designed with two arches to gently hold both the maxillary and mandibular dental arches in a fixed position angled slightly open in such a way as to not stimulate any part of the oral cavity or oropharynx so a fully wide awake user would tolerate it. It would be made of a resilient material such as a soft plastic with a foam insert to hold the teeth or edentulous arches. It is shaped to conform to the teeth and maxillary and mandibular anatomy, and easily inserted by the user him/herself By gently maintaining the mouth slightly open it would enhance the patency of the airway. The mandibular (jaw) thrust feature capitalizes on the unique anatomy of the human tempormandibular joint wherein anterior (frontal) movement of only a few millimeters changes the joint from a hinge to a can, and both motions are separate: thus thrusting the mandibular component a mere few millimeters elevates that mandibular condyle, opening the orpharynx without gagging the patient or further opening the mouth, enhancing airway patency. It's usefulness would include that of a clinical airway in awake to sedated or anesthetized or obtunded patients that may be more flexible than currently available airway support devices since it may be tolerated until the user is fully awake. Another use might be in Obstructive Sleep Apnea (OSA) as the patient may place it themselves and tolerate it as they sleep with airway support that could supplement or replace current therapies. In the Glossal Variant a shallow arch bridges the premolar edges of the mandibular component to gently hold the tongue in place without gagging the user and to allow the user to thrust and/or place his/her tongue in front of the arch, behind or over the incisor portion of the mandibular component, enhancing the Awake Airway's potential to maintain a patent airway.

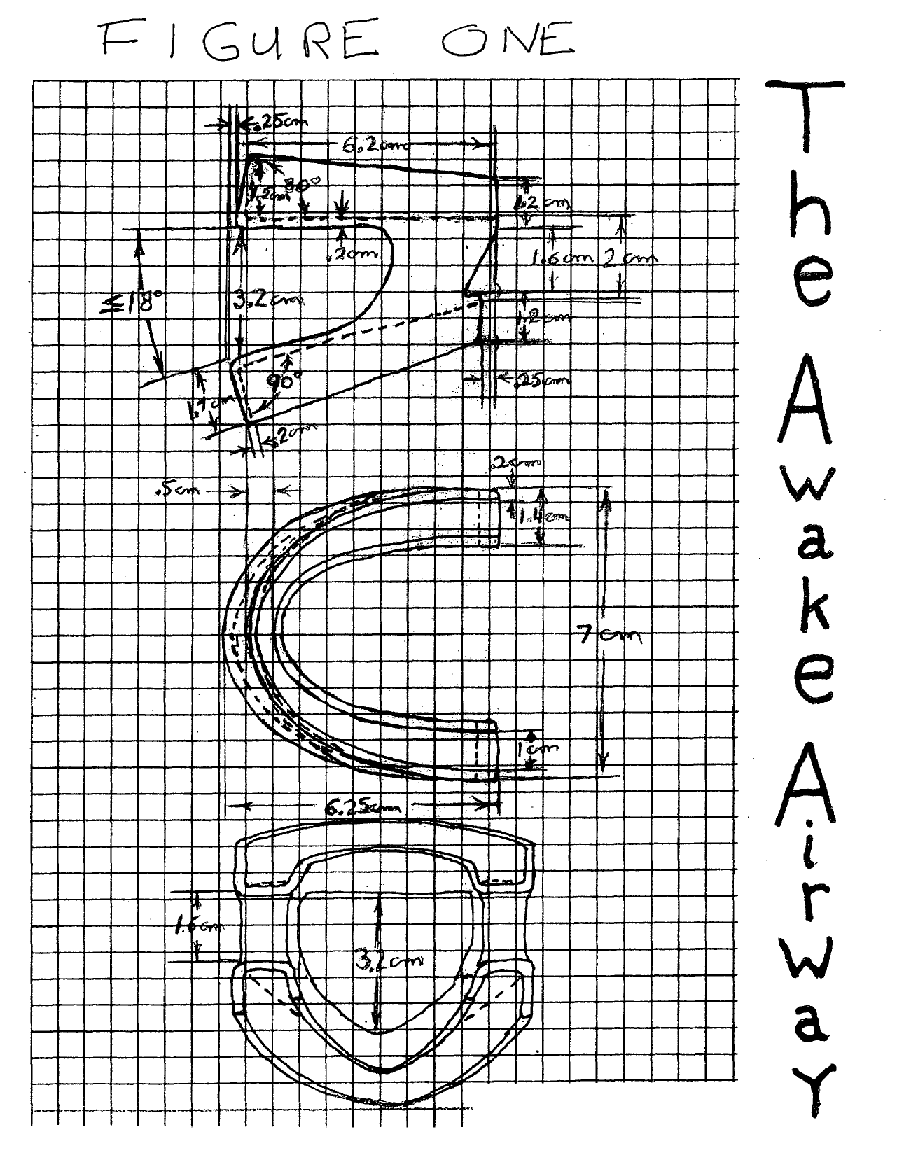

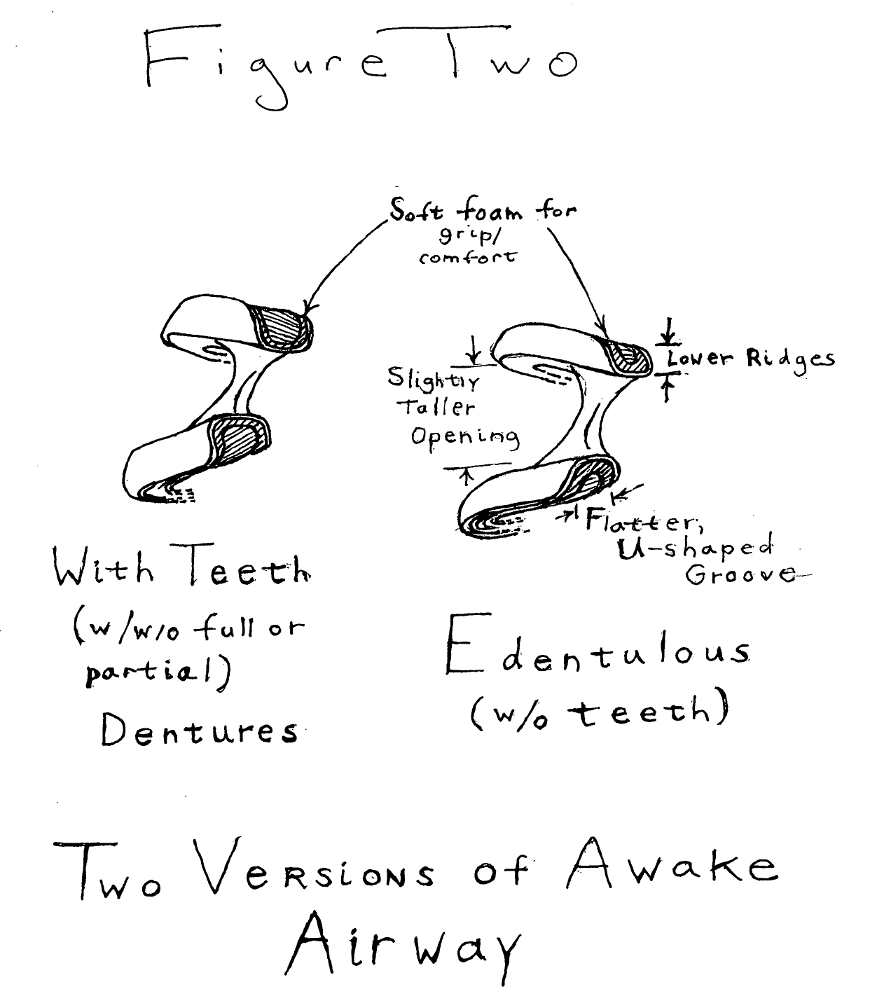

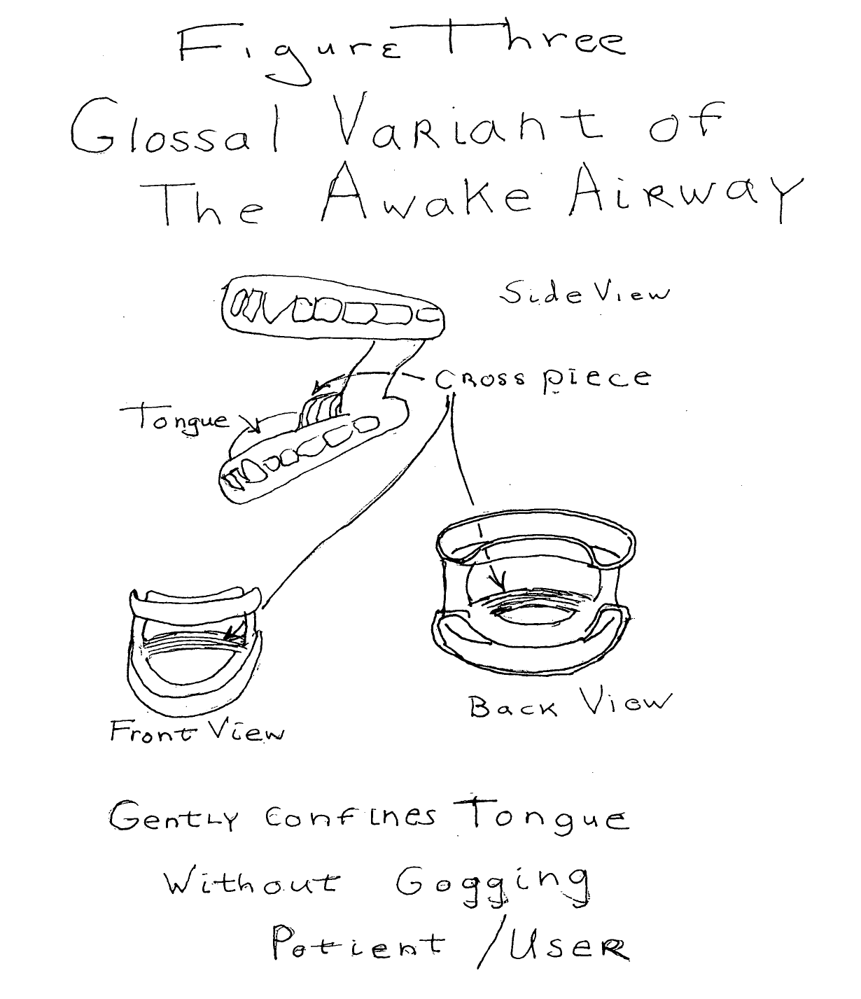

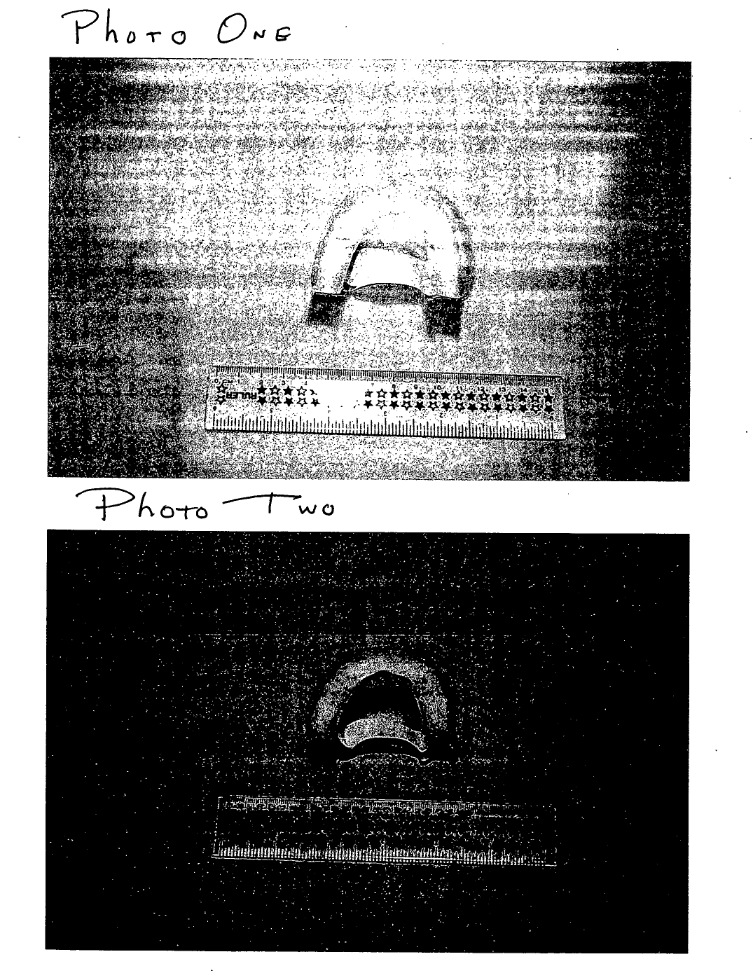

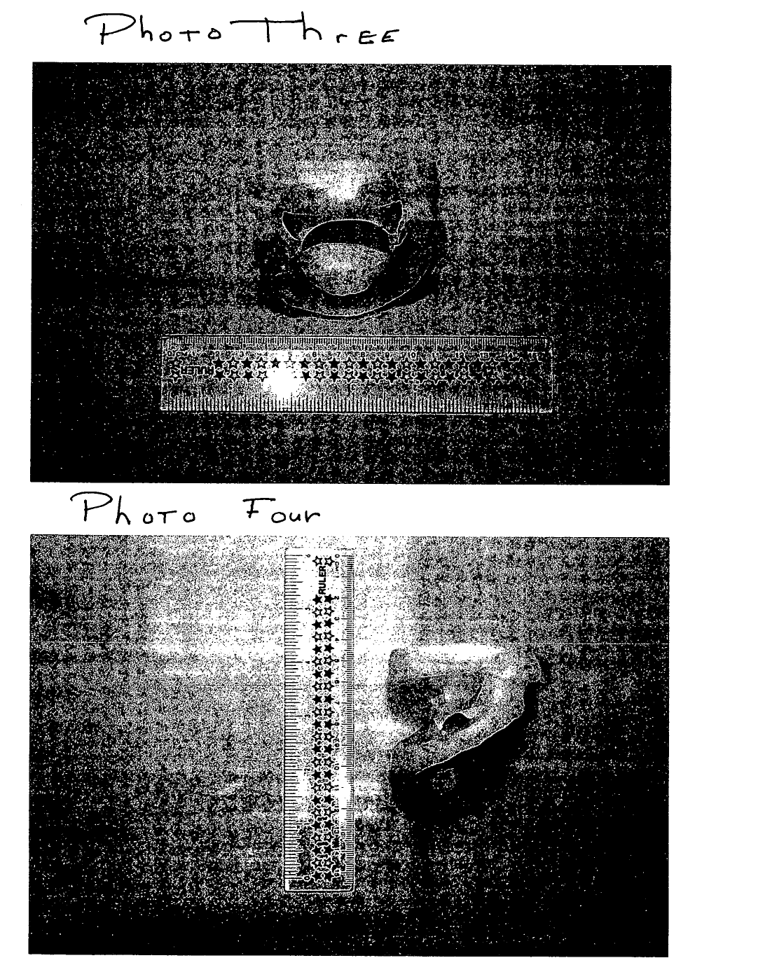

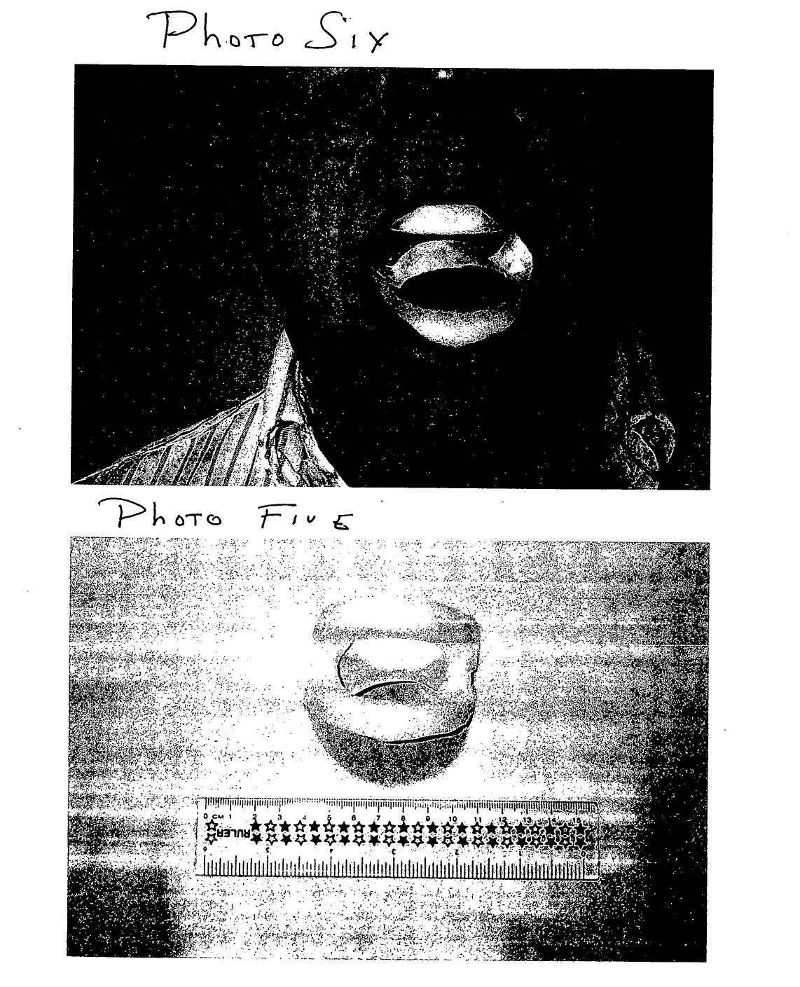

### DESCRIPTION AND SPECIFICATION

We are seeking five patents, one design and four utility patents for a new airway/oral appliance designed to be non stimulating (will not gag) in the awake user which will help to maintain a patent upper airway, even as the patient becomes somnolent, sedated or even anesthetized. It is designed to fit over the dental arches or alveolar ridges (in the edentulous), maintaining an open oral cavity with a large opening, ensuring air passage as well as possible passage of endoscopic devices or other airways.

The appliance would be made of soft non-toxic plastic, and the channel for the dental arches could have a soft insert, made flatter and thicker for the edentulous, preserving the geometry of maintaining the open airway. That is to say there can be an edentulous (toothless) and toothed version. The toothed version could accommodate denture (full or partial) wearers.

No part of the device will touch any area of the oral cavity that might gag or noxiously stimulate the user. These are easily defined and described. This non-gagging feature of the airway is the first utility patent application.

By gently holding the teeth or alveolar ridge (with soft material) the internal version of the jaw thrust maneuver to further maintain an open airway. The airway can be made in sizes to fit children to large adults and made in different forms with differing amounts of mandibular advancement. This is the second utility patent application.

A variant is also proposed that includes an arch to gently hold down the tongue and hold it forward, touching non-gagging portions of the tongue. This could be used in patients with large tongues, or small mandibles. How much the tongue is depressed can be varied. This is the third utility patent application.

Incorporating a securing device on the upper (maxillary) arch for other airways such as an endotracheal tube in the ventilated patient is the basis for seeking a fourth utility patent.

The Airway's unique shape with two dental arches and a smoothly arching connector column between them would be a unique and easily recognized shape. This reason we are seeking a design patent for the Awake Airway.

The Airway's availability in a variety of sizes, varying mandibular advancement, and tongue component does not detract from its unique appearance Thus there would be six versions of the Awake Airway: a toothed and edentulous version of the standard Awake Airway, two versions of the Glossal Variant of the Awake Airway, and two versions of the Variant of the Awake Airway with a fixation component for other airway devices.

### USES

Potential uses for this device include:

As an airway splint in a fully awake patient to allow endoscopic examination with or without sedation. With sedation it would likely maintain on open airway better than currently available devices.

Airway for use with deep sedation and general anesthesia: May be placed with the patient awake and conversely tolerated at the end to a fully awake state. On emerging from deep sedation and general anesthesia there is a transition period when the patient may not tolerate current upper airway devices (oral pharyngeal airways like the Berman airway, nasophayngeal airways, and pharyngeal airways like the Laryngeal Mask Airway), yet still not be able to keep their upper airway patent.

Airway can be used in the Operating Room or Procedure Suite with an endotracheal tube or Pharyngeal airway, since the tube portions can be passed through the Airway and secured through them.

Useful as a splint for bruxism, or teeth grinding, including in sleep Airway may have potential use in those with Obstructive Sleep Apnea (OSA) to maintain a patent upper airway in sleep alone or as an adjunct to Continuous Positive Airway Pressure (CPAP) Devices and other treatments. In addition these individuals are often obese or morbidly obese. They are commonly the patients described above with the problem of airway obstruction when mildly sedated and cannot tolerate classic airways. In this sleep apnea application it might be used are home during sleep. Its large size, and open design protects against aspiration or airway obstruction, a condition it's designed to help.

Drawings and photos are submitted with each application

I claim

1. A parabolic arch shaped support to gently and firmly grasp the maxillary dental arch; the support covering from the incisor teeth to the molar teeth or, for the edentulous, the entire maxillary alveolar arch; the support comprised of a resilient and firm material molded into a cross-sectional u-shape; an outside (buccal) edge or lip and inside (lingual) edge or lip comprising the two sides of the cross sectional u-shape, with a softer foam material inserted inside the resilient material

2. a second support arch as claimed in claim 2 to also have a parabolic arch shaped to follow the mandible also having an insert of foam material in the cross-sectional u shape with a buccal and lingual lip and floor to gently hold the teeth or alveolar ridges with differing thicknesses to accommodate them

3. the floor or bottom of the cross sectional u shape as claimed in claim 1 for the maxillary arch and in claim 2 for the mandibular arch to be narrow at the peak of the arch to accommodate the incisor teeth, widening toward both legs of the arch, maximum at the edge to accommodate the molar teeth/ or wider alveolar ridge.

4. an outside (buccal) lip and an inside (lingual) lip as claimed in claim 1 and in claim 2 to be angled a few degrees (circa 15) degrees) posteriorly from a vertical from the base of the support as claimed in claim one and claim two and to be sufficiently high to cover the incisor teeth at the apes of the arch.

5. an outside buccal lip and an inside (lingual) lip as claimed in claim 1 and in claim 2 to have the angle from the base of the support approach back to vertical as it is molded toward the molar teeth and to diminish in height to just cover the molar teeth (usually lower than the incisor teeth).

6. An inside (lingual) lip or edge as claimed in claims 4 and 5 to be shorter than the outside (buccal) lip or edge to better conform to the angle of the mucosa arising from the lingual edge of the incisor teeth.

7. An inside (lingual) lip or edge as claimed in claim 1 and claim 2 to taper more that the outside (buccal) lip or edge to accommodate the fuller and flatter angle of the lingual mucosa.

8. a buttress or arch molded in the maxillary support as claimed in claim 1 to be affixed to the mandibular arch support in claim 2 reversed 180 degrees from the maxillary support to gently grasp the mandibular dental arch so as to hold the two arches angled open from one another

9. the buttress in claim 8 to be molded into the molar portions of the maxillary and mandibular arches, extending forward toward the premolars, and molded not to extend beyond the edge of either the mandibular or maxillary arches so as to have no edges, just a smooth molded surface

10. a buttress or arch as claimed in claim 8 to have an oval to rounded rectangular cross sectional shape at all levels including its attachment to the underside of the alveolar arch support and to angle the two alveolar arch supports to obtain an opening of more than a centimeter and/or an angle of 15 degrees and maintain term in that relationship.

11. two arch supports as claimed in claim 1 and claim 2 and a buttress or arch as claimed in claim 8 together to gently mold and grasp the maxilla and mandible, whether with teeth or edentulous, and keep the mouth gently but firmly opened without touching any oral or pharyngeal structures that would gag or stimulate the wearer

12. a buttress or arch as claimed in claim 8 and claim 11 that gently advances the mandibular arch forward (frontally) sufficiently to engage the cam joint mechanics of the human Temporo-mandibular joint to open the oropharynx and maintain patency of the airway

13. a buttress or arch as claimed in claim 8 and 11 to have a smooth sigmoid shape from the maxillary to mandibular supports, thereby holding an open angle between the two arches of approximately 15 degrees and a frontal positioning of the mandibular arch vis-a-vis the maxillary arch to position the mandibular condyle over the meniscus of the temporomandulbar joint exploiting its cam mechanics.

14. an arch to be molded of a single piece with the airway bridging the premolar/molar portions of the mandibular arch as claimed in claim 2 with an opening in front to the incisor (peak) portion of the arch to rise only a few millimeters in the center to cover the middle portion of the tongue and not touch the posterior one third of the tongue both ends of the tongue arch

15. the arch as claimed in claim 14 to be ovoid in cross section and only a couple of millimeters thick in the center, so as to be able to contain the tongue and to hold it gently to the floor of the mouth

16. the edges of the arch claimed in claim 14 to be rounded to be comfortable for the wearer with an anterior (frontal) space adequate to comfortably accommodate the tongue.
